(19) United States
(12) Patent Application Publication
(10) Pub. No.: US 2024/0372298 A1
(43) Pub. Date: Nov. 7, 2024

(54) ELECTRONIC MODULE WITH INTEGRATED CONNECTOR POSITION ASSURANCE DEVICE

(71) Applicant: Aptiv Technologies AG, Schaffhausen (CH)

(72) Inventors: Kevin Jump, West Bloomfield, MI (US); John Mecca, Oakland Township, MI (US); Jeff Livingston, Davison, MI (US)

(21) Appl. No.: 18/654,500

(22) Filed: May 3, 2024

Related U.S. Application Data
(60) Provisional application No. 63/463,607, filed on May 3, 2023.

(51) Int. Cl. H01R 13/631; H01R 13/641

(52) U.S. Cl. CPC H01R 13/631; H01R 13/641

(57) ABSTRACT

A system for securing a cable assembly to an electronic module. The system comprises a first housing, a connector position assurance device, and a cable. The first housing includes a connector port with a socket and a retention tab. The first housing includes a wall having an outer surface. The connector position assurance device is movably coupled to the first housing. The connector position assurance device includes an actuation tab positioned on the outer surface of the wall and a locking arm extending into the connector port. The cable includes a conductive element and a locking member. The conductive element of the cable is received in the socket of the first housing.

### CROSS-REFERENCE TO RELATED APPLICATIONS

This application claims the benefit of and priority to U.S. Provisional Application No. 63/463,607 titled “ELECTRONIC MODULE WITH INTEGRATED CONNECTOR POSITION ASSURANCE DEVICE,” filed May 3, 2023, the contents of which are incorporated by reference herein.

### TECHNICAL FIELD

The subject matter disclosed herein relates to electrical connectors and, in particular, to connector position assurance (CPA) devices for cable harness connectors.

### BACKGROUND

In general, a cable wire harness in a vehicle includes a connector and a housing (or module) to receive the connector. The connector includes an electrical terminal configured to electrically couple with a socket (or output terminal) of the housing. The connector can include a connection position assurance (CPA) device to ensure that the connector is properly positioned relative to the housing. The CPA device is located on the connector portion of the cable wire harness. For example, the CPA device may be slid forward or actuated on the connector when the connector is fully seated within the housing.

### SUMMARY

According to one aspect, a system for securing a cable assembly to an electronic module. The system comprises a first housing, a connector position assurance device, and a cable. The first housing includes a connector port with a socket and a retention tab. The first housing includes a wall having an outer surface. The connector position assurance device is movably coupled to the first housing. The connector position assurance device includes an actuation tab positioned on the outer surface of the wall and a locking arm extending into the connector port. The cable includes a conductive element and a locking member. The conductive element of the cable is received in the socket of the first housing.

According to another aspect, an electronic module. The electronic module includes a first housing and a connector position assurance device. The first housing includes a connector port having a socket configured to receive a conductive element of a cable. The first housing includes a wall including an outer surface. The connector position assurance device includes an actuation tab positioned on the outer surface of the wall of the first housing and a locking arm extending into the connector port. A frame member couples the actuation tab to the locking arm. The locking arm is movably coupled to the first housing.

According to another aspect, a connector position assurance assembly for an electronic module. The connector position assurance assembly comprises a connector position assurance device including an actuation tab and an intermediate tab oriented parallel to the actuation tab. A dividing member is positioned between the actuation tab and the intermediate tab. A locking arm is connected to the intermediate tab via a frame member. The locking arm includes a tongue and a locking pin forming a receiving slot therebetween.

### BRIEF DESCRIPTION OF THE DRAWINGS

FIG. 1 is an isometric view of an electronic housing including a connector position assurance (CPA) device, according to some embodiments.

FIG. 2 is an isometric view of a cable with a cable connector, according to some embodiments.

FIG. 3A is an isometric front view of a CPA device for an electronic housing, according to some embodiments.

FIG. 3B is an isometric rear view of a CPA device for an electronic housing, according to some embodiments.

FIG. 4A is an isometric front view of a CPA device positioned on a first housing of an electronic housing, according to some embodiments.

FIG. 4B is an isometric rear view of a CPA device positioned on a first housing of an electronic housing, according to some embodiments.

FIG. 5A is an isometric front view of a CPA device in a release position on a first housing with a cable positioned in a connector port, according to some embodiments.

FIG. 5B is a cross sectional side view of a CPA device in a release position on a first housing with a cable positioned in a connector port, according to some embodiments.

FIG. 5C is an isometric front view of a CPA device in a lock position on a first housing with a cable positioned in a connector port, according to some embodiments.

FIG. 5D is a cross sectional side view of a CPA device in a lock position on a first housing with a cable positioned in a connector port, according to some embodiments.

FIG. 6A an isometric front view of a CPA device for an electronic housing, according to some embodiments.

FIG. 6B is an isometric rear view of a CPA device for an electronic housing, according to some embodiments.

FIG. 7A is an isometric front view of a CPA device positioned on a first housing of an electronic housing, according to some embodiments.

FIG. 7B is an isometric rear view of a CPA device positioned on a first housing of an electronic housing, according to some embodiments.

FIG. 8A is an isometric front view of a CPA device in a release position on a first housing with a cable positioned in a connector port, according to some embodiments.

FIG. 8B is a cross sectional side view of a CPA device in a release position on a first housing with a cable positioned in a connector port, according to some embodiments.

FIG. 8C is an isometric front view of a CPA device in a lock position on a first housing with a cable positioned in a connector port, according to some embodiments.

FIG. 8D is a cross sectional side view of a CPA device in a lock position on a first housing with a cable positioned in a connector port, according to some embodiments.

FIG. 9 is an isometric view of an electronic housing including a CPA device and a cable assembly, according to some embodiments.

FIG. 10 is a flow chart of a method of securing a cable to an electronic housing with a CPA device, according to some embodiments.

### DETAILED DESCRIPTION

The present disclosure describes a connector position assurance (CPA) device located on the electronic housing. The CPA device is movable on the electronic housing from a release position to a lock position, and vice-versa. The electronic housing includes a connector port configured to receive a connector therein. The CPA device engages the connector upon insertion of the connector within the connector port of the electronic housing. The connector urges or flexes a locking pin of the CPA device into a movable state. The CPA is actuated via user input on the actuation tab, e.g., the CPA device is slid forward toward the connector port. A tongue disposed on the CPA device engages a locking member of the connector to hold the locking member in the lock position. Positioning the CPA device on the electronic housing (as opposed to positioning the CPA device on the connector) allows a connector port to be compatible with a number of different cable connectors (i.e., from various manufacturers). For instance, instead of relying on a cable connector manufacture to provide a CPA device on the cable, the electronic housing manufacturer can provide a CPA device on the electronic housing configured to lock onto standard cable connectors (e.g., LVDS Mini B connector which does not include an CPA device or secondary lock).

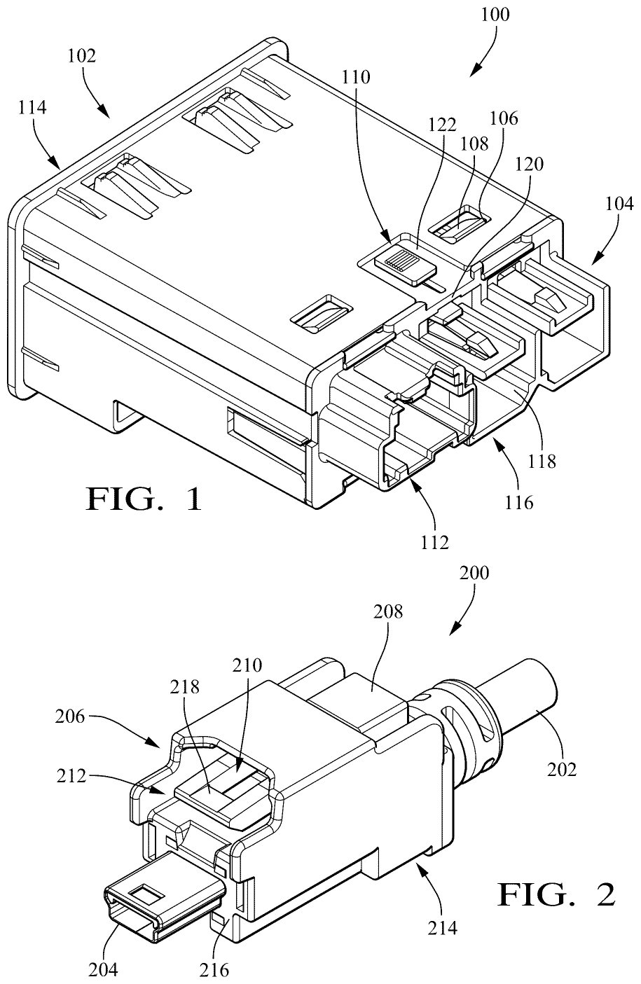

FIG. 1 is an isometric view of an electronic housing 100 including a connector position assurance (CPA) device 110, according to some embodiments. The electronic housing 100 (also referred to as the electronic module 100) includes a front housing 102 with a locking surface 106 secured to a rear housing 104 with a locking tab 108. The front housing 102 is located at a second end 114 and the rear housing 104 is located at a first end 112. The rear housing 104 includes a connector port 116, a socket 118, and a wall 120 having an outer surface 122.

In some embodiments, the front housing 102 and the rear housing 104 (also referred to as the first housing 104) are secured together via the locking tab 108 of the rear housing 104 engaging the locking surface 106 of the front housing. The CPA device 110 is positioned on the rear housing 104. Securing the front housing 102 to the rear housing 104 prevents the CPA device 110 from being removed from the electronic housing 100.

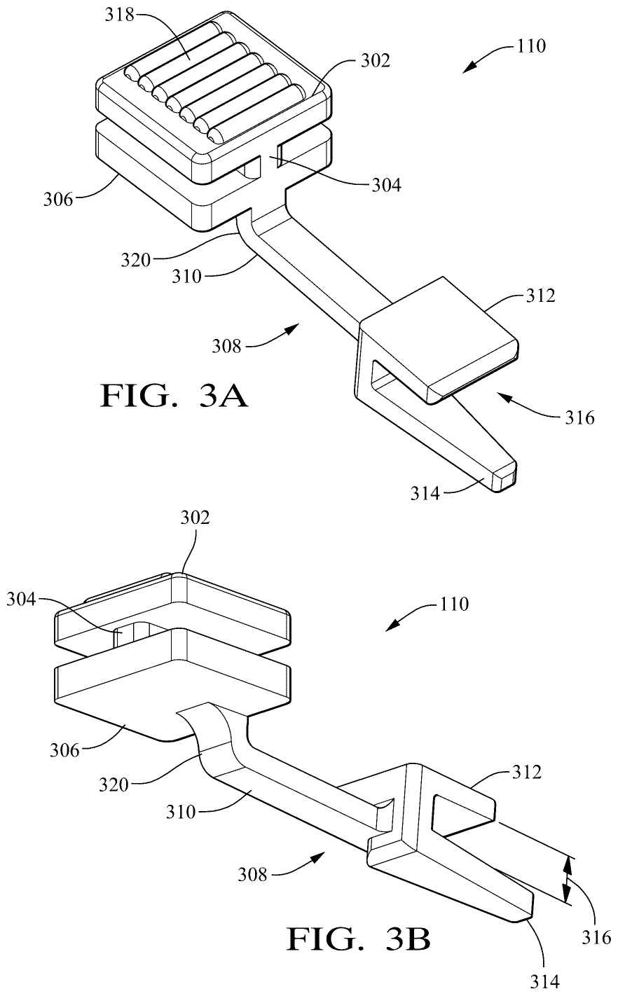

FIG. 2 is an isometric view of a cable assembly 200 with a cable connector 206, according to some embodiments. The cable assembly 200 includes a cable 202, a conductive element 204, a connector body 214 having a connector face 218. The cable connector 206 includes an actuator 208, a connector channel 212, and a biased locking member 210 having a locking member surface 218.

In some embodiments, the cable assembly 200 is a LVDS Mini B cable (low voltage differential signaling minibus connector), including for example, Molex® USB 2.0 Cable Mini B male connector cable. The cable connector 206 provides a primary locking mechanism for the cable assembly 200, as for instance, the connector channel 212 receives a feature of the electronic housing (e.g., a wall) therein and the biased locking member 210 engages a retention tab. The biased locking member 210 is biased to rest against the connector body 214, and therefore, the biased locking member 210 can lock a feature of the electronic housing in-place. Actuation of the actuator 208 (e.g., a user pressing the actuator 208) raises the biased locking member 210 via a cantilever mechanism to release the feature of the electronic housing from the cable connector 206.

In some embodiments, the conductive element 204 of the cable assembly 200 is a male connector. The electronic housing 100 includes a female conductive element (not shown) within the socket 118 of the connector port 116 to mate with the male connector.

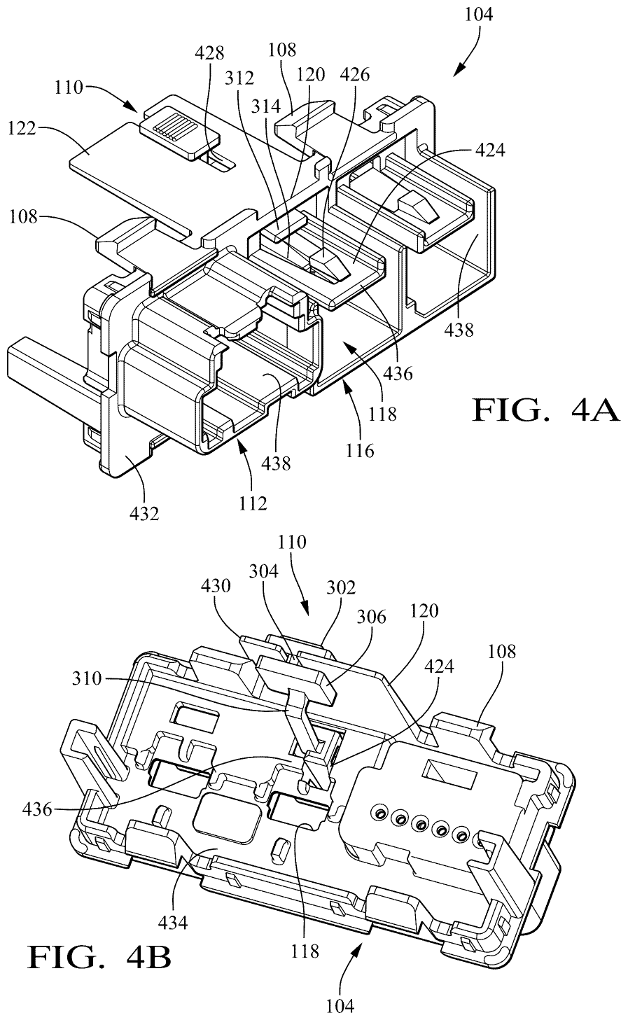

FIG. 3A is an isometric front view of a CPA device 110 for an electronic housing 100 and FIG. 3B is an isometric rear view of a CPA device 110 for an electronic housing 100 according to some embodiments. The CPA device 110 includes an actuation tab 302, a dividing member 304, an intermediate tab 306, a locking arm 308, a frame member 310, a tongue 312, a locking pin 314, a receiving slot 316, a user interface feature 318, and an elbow 320, according to some embodiments.

In some embodiments, the actuation tab 302 is secured to the intermediate tab 306 via the dividing member 304. The actuation tab 302 defines a plane approximately parallel to a plane of the intermediate tab 306. The dividing member 304 intersects the plane of the actuation tab 302 and the plane of the intermediate tab 306 at a perpendicular angle. The dividing member 304 spaces the actuation tab 302 from the intermediate tab 306 such that the intermediate tab 306 does not contact the actuation tab 302. The actuation tab 302 includes user interface feature(s) 318, e.g., ridges or groves to improve grip for the user.

The locking arm 308 extends from the actuation tab 302 and/or the intermediate tab 306, according to some embodiments. The locking arm 308 includes the frame member 310, the tongue 312, and the locking pin 314. In some embodiments, the frame member 310 is an elongate arm extending along the centerline of the CPA device 110. In some embodiments, the frame member 310 is flexible, as for example, a load force can be placed on the locking pin 314 and/or the tongue 312 to deflect the frame member 310. The tongue 312 and the locking pin 314 are spaced apart to form the receiving slot 316 which can be configured to capture one or more features of the electronic housing 100 and/or the cable assembly 200 therein. The tongue 312 defines a plane approximately parallel to a plane of the locking pin 314, and in some embodiments, the respective planes of the actuation tab 302, the intermediate tab 306, the tongue 312, and the locking pin 314 are approximately parallel.

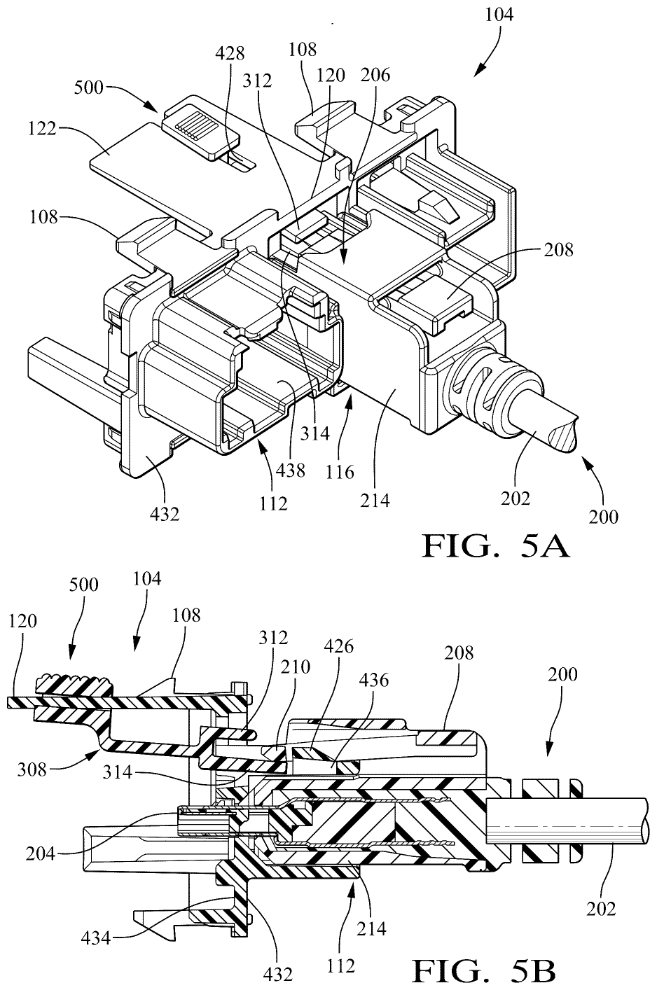

FIG. 4A is an isometric front view of a CPA device 110 positioned on a rear housing 104 of an electronic housing 100 and FIG. 4B is an isometric rear view of the CPA device 110 positioned on the first housing 104, according to some embodiments.

The first housing 104 includes a retention channel 424, a retention tab 426, a slot 428, an inner surface 430, a rear housing face 432, an interior face surface 434, a bifurcation wall 436, and additional ports 438, according to some embodiments.

The slot 428 extends through the outer surface 122 and the inner surface 430 of the wall 120. The CPA device 110 is received within the slot 428 such that the actuation tab 302 is positioned above (or exterior to) the outer surface 122 and the intermediate tab 306 is positioned within (or interior to) the inner surface 430. The CPA device 110 is slideable along the slot 428 as the dividing member 304 acts as a rail guiding the movement of the CPA device 110. In some embodiments, the actuation tab 302 engages the outer surface 122 and/or the intermediate tab 306 engages the inner surface 430.

The bifurcation wall 436 divides the connection port 116 into the socket 118 portion and the retention channel 424 portion. The bifurcation wall 436 includes the retention tab 426 extending into the retention channel 424 portion of the connection port 116. The retention tab 426 limits rearward travel of the CPA device 110, as for example, the locking pin 314 of the CPA device 110 engages the retention tab 426 to prevent rearward travel of the locking pin 314. In some embodiments (as described in-detail below), insertion of the cable assembly 200 into the connector port 116 deflects the locking pin 314 from the retention tab 426 (e.g., via flexing the locking arm 308 toward the socket 118 portion) to allow rearward travel of the locking pin 314 past the retention tab 426.

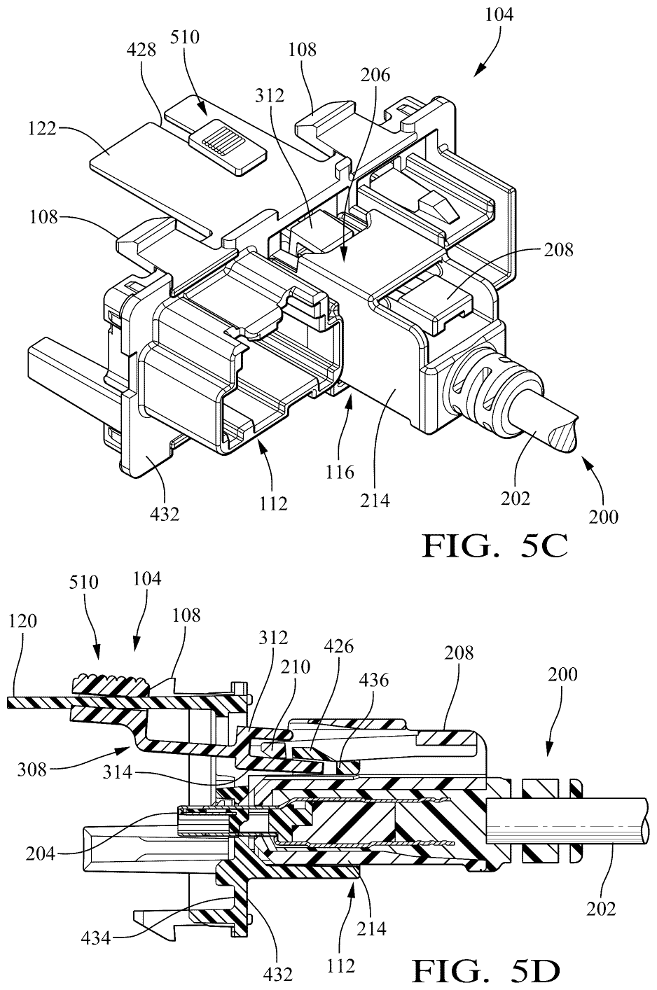

FIG. 5A is an isometric front view of a CPA device 110 in a release position 500 on a first housing 104 with a cable assembly 200 positioned in a connector port 116 and FIG. 5B is a cross sectional view of the CPA device 110 in the release position on the first housing 104 with the cable assembly 200 positioned in the connector port 116, according to some embodiments. The cable assembly 200 is positioned such that the conductive element 204 extends through the socket 118 and into the inner cavity of the electronic housing, i.e., extending interior of the interior face surface 434. In other words, the cable assembly 200 is fully seated within the electronic housing 100.

In some embodiments, inserting the cable assembly 200 into the connector port 116 generates engagement between the locking arm 308 and the cable connector 206. For instance, the biased locking member 210 of the cable connector 206 is urged forward toward the locking pin 314 of the locking arm 308. Upon full insertion of the cable assembly 200 into the connector port 116, the biased locking member 210 deflects the locking pin 314 away from the retention tab 426. The locking pin 314 is deflected (or flexed) to a position between the bifurcation wall 436 and the socket 118 (e.g., under the retention tab 426), according to some embodiments. For instance, FIG. 5B illustrates the locking arm 308 flexed in a direction away from the wall 120 (e.g., the frame member 310 flexes in a direction away from the wall 120).

In some embodiments, the CPA device 110 provides an indication of whether the cable assembly 200 is fully inserted (or fully seated) within the connector port 116, as the CPA device 110 can be actuated (i.e., slid rearward toward the first end 112) only when the cable connector 206 is fully inserted. For instance, full insertion of the cable assembly 200 in the connector port 116 generates engagement between the cable connector 206 and the locking arm 308, thereby deflecting the locking pin 314 away from the retention tab 426. A partial insertion of the cable assembly 200 in the connector port 116 will not disengage the locking pin 314 from the retention tab 426, thereby inhibiting rearward travel of the CPA device 110 (i.e., the CPA device 110 cannot be actuated to a locking position).

In some embodiments, inserting the cable assembly 200 into the connector port 116 generates engagement between the cable connector 206 and the bifurcation wall 436. For example, the biased locking member 210 of the cable connector 206 engages the retention tab 426 of the bifurcation wall 436. The biased locking member 210 includes a rear-facing surface or feature that engages a forward-facing surface or feature of the retention tab 426 to lock the cable assembly 200 onto the electronic housing, according to some embodiments. For example, if a force acts to pull the cable assembly 200 away from the electronic housing 100, the engagement between the biased locking member 210 and the retention tab 426 (i.e., a primary lock) prevents the cable assembly 200 from leaving the connector port 116. To remove the cable assembly 200 from the connector port 116, a user can actuate the actuator 208 to lift the biased locking member 210 (e.g., via a cantilever mechanism). Lifting the biased locking member 210 via the actuator 208 disengages the biased locking member 210 from the retention tab 426 to allow the cable assembly 200 to be removed, according to some embodiments.

FIG. 5C is an isometric front view of a CPA device 110 in a lock position 510 on the first housing 104 with the cable assembly 200 positioned in the connector port 116 and FIG. 5D is a cross sectional view of the CPA device 110 in the lock position 510 on the first housing 104 with the cable assembly 200 positioned in the connector port 116, according to some embodiments. The CPA device 110 is moved rearward (i.e., in a direction toward the connector port 116) along the slot 428 from the release position 500 (as shown in FIGS. 5A-B) to the lock position 510 (as shown in FIGS. 5C-D). In the lock position 510, the locking arm 308 of the CPA device 110 engages the biased locking member 210 and the bifurcation wall 436. For instance, the receiving slot 316 of the locking arm 308 receives the biased locking member 210 and the bifurcation wall 436 therein.

The locking position 510 of the CPA device 110 prevents the biased locking member 210 from being disengaged from the retention tab 426, as for example, the biased locking member 210 is prevented from being raised or actuated (via the actuator 208 acting as a cantilever). Thus, the locking position 510 of the CPA device 110 is a secondary lock (or lock assurance), as the user must first actuate the CPA device 110 from the locking position 510 to the release position 500, and then actuate the actuator 208 to disengage the biased locking member 208 from the retention tab 426.

The CPA device 110 provides an indication of whether the cable assembly 200 is in the correct position (i.e., fully seated with the conductive element 204 electrically coupled to a female connector). For instance, the CPA device 110 can only be moved into the lock position 510 if the cable assembly 200 is fully inserted into the connector port 116. The indication of full insertion of the cable assembly 200 within the connector port 116 is beneficial, as it ensures an electrical connection between the cable assembly 200 and the female connector—or in other words, if the CPA device 110 is in the locking position 510, an electrical connection is guaranteed.

The CPA device 110 provides a secondary locking mechanism to ensure that the cable assembly 200 is secured to the electronic housing 100. The primary locking mechanism includes the engagement between the biased locking member 210 of the cable connector 206 and the retention tab 426 of the rear housing 104, according to some embodiments. The secondary locking mechanism includes the locking arm 308 of the CPA device 110 engaging the biased locking member 210 and/or the retention tab 426 to prevent disengagement of the primary lock, according to some embodiments. The tongue 312 contacts the locking member surface 218 to prevent the biased locking member 210 from traveling away from the retention tab 426, according to some embodiments. The secondary locking function of the CPA device 110 is beneficial, as it prevents unintentional disengagement of the primary locking mechanism.

The CPA device 110 is positioned on the electronic housing 100. The CPA device 110 is movable between the release position 500 on the rear housing 104 and the locking position 510 on the rear housing 104. Locating the CPA device 100 on the electronic housing 100 (as opposed to locating the CPA device on the cable assembly 200) is beneficial because it provides connector position assurance to cable assemblies that otherwise would not have a connector position assurance feature. For instance, current manufacturers of LVDS Mini B connectors do not provide a connector position assurance feature or device on the connector. Thus, positioning the CPA device 110 on the electronic housing 100 provides connector position assurance functionality to an LVDS Mini B connector. Positioning the CPA device 110 on the electronic housing 100 enables the CPA device 110 to be compatible with different cable assemblies or manufacturers. For example, the CPA device 100 may be compatible with an LVDS Mini B male connector manufactured by company A (e.g., Molex®) and may be compatible with an LVDS Mini B male connector manufactured by company B (e.g., Aptiv®).

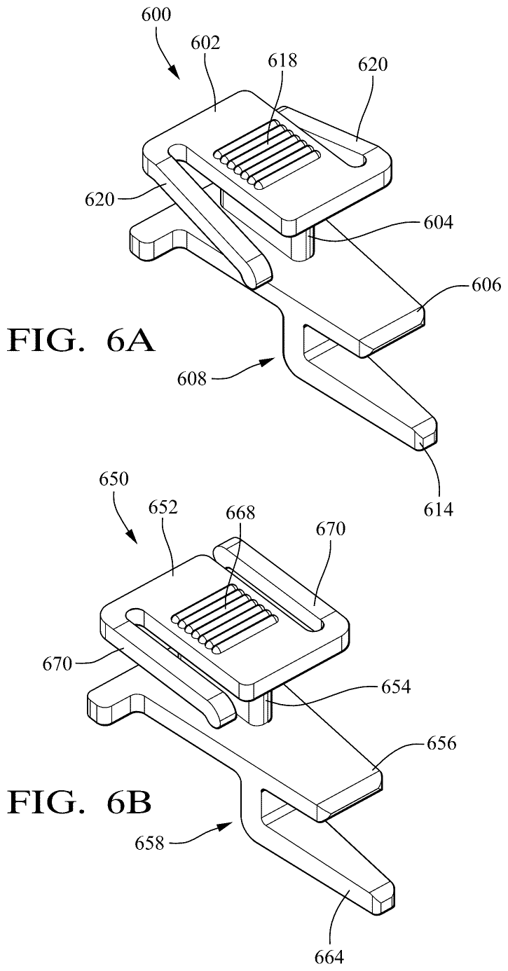

FIG. 6A is an isometric front view of a CPA device 600 for an electronic housing 100. The CPA device 600 includes an actuation tab 602, a dividing member 604, a tongue 606, a locking arm 608, a locking pin 614, a user interface feature 618, and a biased member 620, according to some embodiments.

FIG. 6B is an isometric front view of a CPA device 650 for an electronic housing 100. The CPA device 650 includes an actuation tab 652, a dividing member 654, a tongue 656, a locking arm 658, a locking pin 664, a user interface feature 668, and a biased member 670, according to some embodiments.

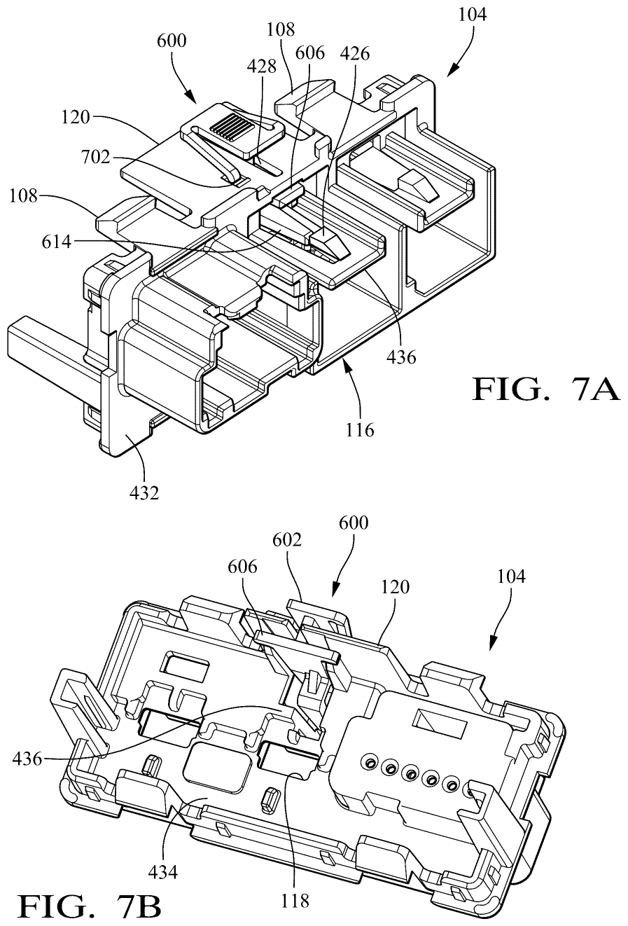

FIGS. 7A-B are isometric views of the CPA device 600 positioned on the rear housing 104 of an electronic housing, according to some embodiments. The biased member(s) 620 of the CPA device 600 engages the wall 120, and in some embodiments, the biased member 620 engages a lock verification detent 702 on the wall 120. The biased members 620 urge the actuation tab 602 away from the wall 120, according to some embodiments.

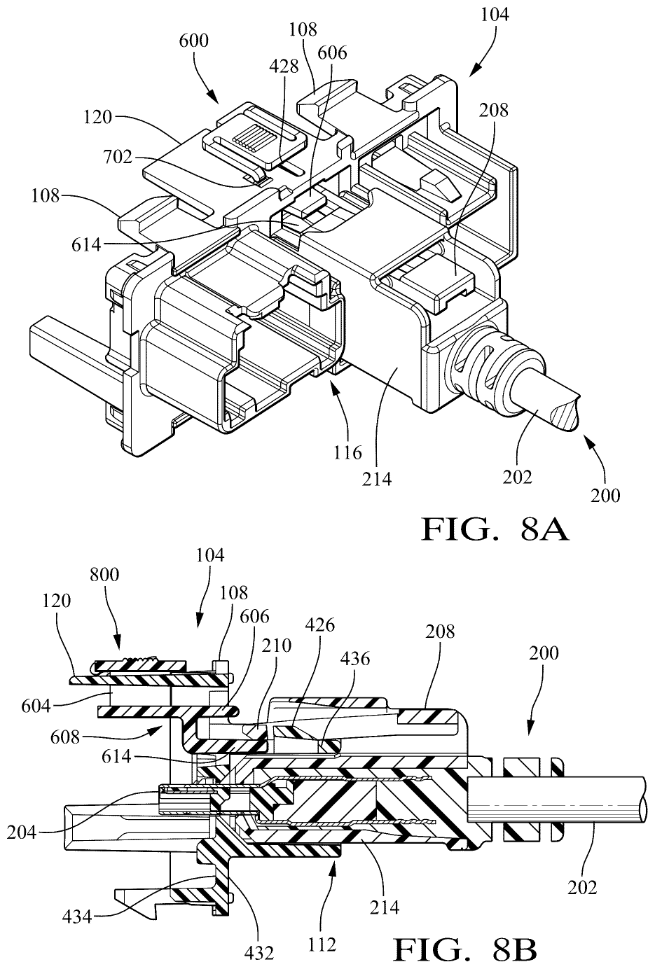

FIGS. 8A-B are isometric and cross sectional views of the CPA device 600 in a release position 800 on the rear housing 104 with the cable assembly 200 positioned in the connector port 116, according to some embodiments. The cable connector 206 engages the CPA device 600 when the cable assembly 200 is properly positioned (i.e., fully inserted) within the connector port 116. The biased locking member 210 of the cable connector 206 contacts the locking pin 614. Such contact urges the locking pin 614 downward and thereby disengages the locking pin 614 from the retention tab 426. The contact between the biased locking member 210 and the locking pin 614 urges the actuation tab 602 toward the wall 120. The biased members 620 flex (e.g., are urged to extend parallel with the wall 120) to allow the CPA device 600 to disengage from the retention tab 426.

FIGS. 8C-D are isometric and cross sectional views of the CPA device 600 in a lock position 810 on the rear housing 104 with the cable assembly 200 positioned in the connector port 116, according to some embodiments. The primary locking mechanism (i.e., the biased locking member 210 engaged with the retention tab 426) is positioned between the tongue 606 and the locking pin 614, according to some embodiments.

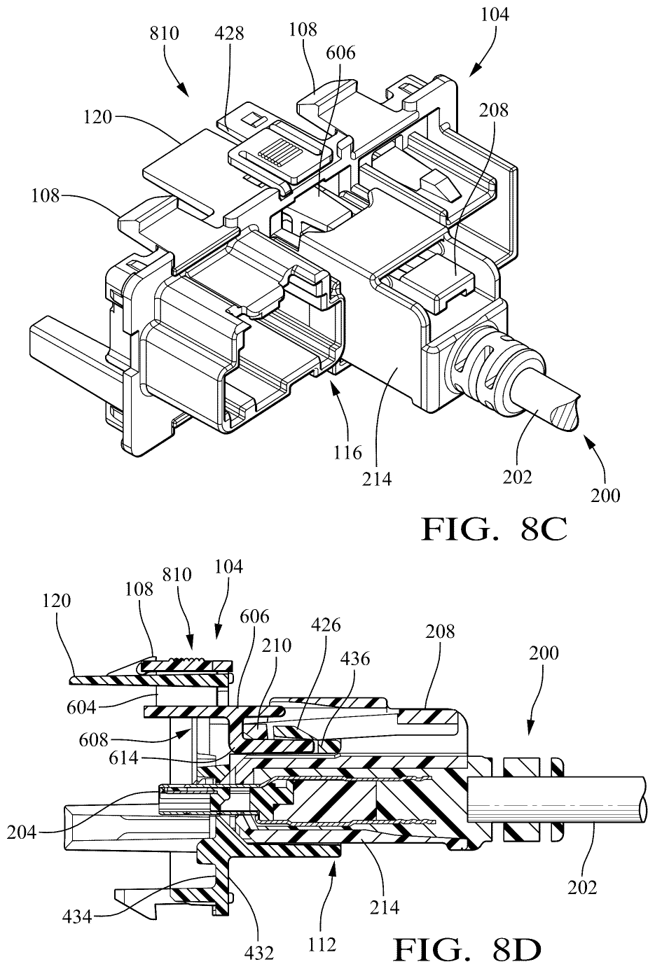

FIG. 9 is an isometric view of an electronic housing 100 including a CPA device 910 and a cable assembly 200, according to some embodiments. The CPA device 910 includes any and/or all features of the CPA device 110, 600, 650 described above. The CPA device 910 includes an actuation tab 902 having a pull tab feature 904. The pull tab feature 904 is configured to provide an ergonomic user interface feature for the user to pull the CPA device 910 to the locking position (i.e., to pull the CPA device 910 toward the first end 112 of the electronic housing 100). In some embodiments, the pull tab feature 904 extends over the cable assembly 200.

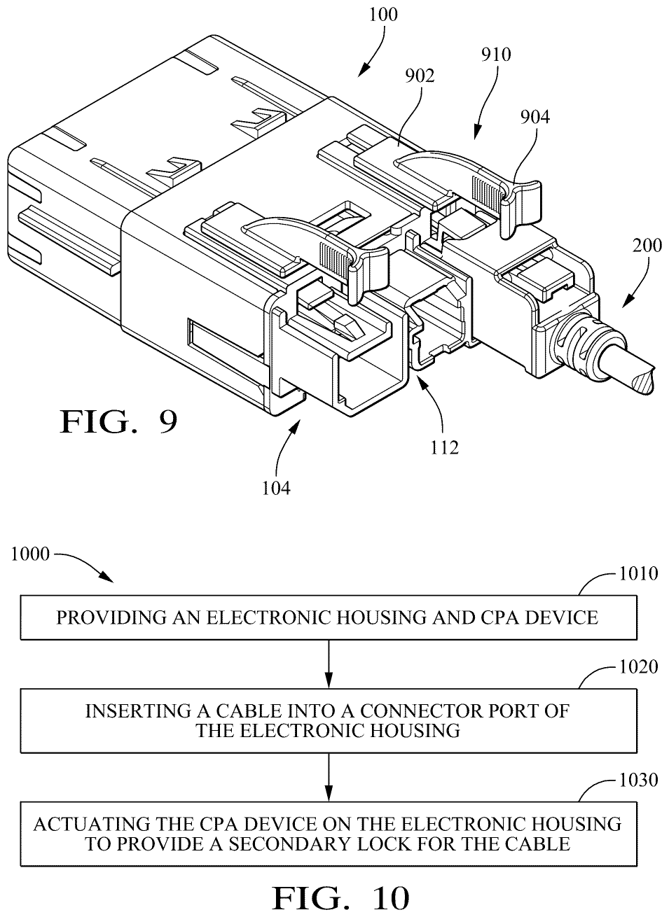

FIG. 10 is a flow chart of a method 1000 of securing a cable to an electronic housing with a CPA device, according to some embodiments. At step 1010, the method 1000 includes providing an electronic housing with a CPA device. The electronic housing includes any and/or all features of the electronic housing 100 described above and the CPA device includes any and/or all features of the CPA device 110, 600, 650, 910 described above.

At step 1020, the method 1000 includes inserting a cable assembly into a connector port of the electronic housing. The cable assembly includes any and/or all features of the cable assembly 200 described above. The conductive element 204 of the cable assembly 200 is inserted into the socket 118 and the cable connector 206 is inserted into the retention channel 424. In some embodiments, the cable connector 206 engages the locking arm 308, 608, 658 of the CPA device 110, 600, 650, 910 to disengage the locking pin 314, 614, 664 from the retention tab 426. The biased locking member 210 engages the retention tab 426 to form a primary lock for the cable assembly 200, according to some embodiments.

At step 1030, the method 1000 includes actuating the CPA device on the electronic housing to provide a secondary lock for the cable. The CPA device 110 is actuated from the release position 500, 800 to the lock position 510, 810. The primary locking mechanism (i.e., the biased locking member 210 engaged with the retention tab 426) is positioned between the tongue 306, 606 and the locking pin 314, 614, according to some embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

According to one aspect, an electronic module. The electronic module includes a first housing and a connector position assurance device. The first housing includes a connector port having a socket configured to receive a conductive element of a cable. The first housing includes a wall including an outer surface. The connector position assurance device includes an actuation tab positioned on the outer surface of the wall of the first housing and a locking arm extending into the connector port. A frame member couples the actuation tab to the locking arm. The locking arm is movably coupled to the first housing.

The electronic module of the preceding paragraph can optionally include, additionally and/or alternatively any, one or more of the following features/steps, configurations and/or additional components.

For example, the electronic module may further include a retention channel on the connector port configured to engage a cable connector. A bifurcation wall is positioned between the socket and the retention channel.

The electronic module may further include the locking arm movable from a release position on the first housing to a locking position within the connector port of the first housing to engage a cable connector.

The electronic module may further include the wall of the first housing including an inner surface. A slot extends through the inner surface and the outer surface of the wall. The connector position assurance device is slidably coupled with the slot.

The electronic module may further include the connector position assurance device including a locking pin positioned in the connector port of the first housing.

The electronic module may further include the locking pin abutting a retention tab positioned on the bifurcation wall when the connector position assurance device is in a release position. The retention tab prevents actuation of the connector position assurance device.

The electronic module may further include the bifurcation wall of the first housing positioned between the tongue and the locking pin in the locking position.

The electronic module may further include the locking arm of the connector position assurance device urged upon receiving the conductive element of the cable within the socket. The locking pin is disengaged from the retention tab upon receiving the conductive element of the cable within the socket.

The electronic module may further include the locking arm including a tongue. The tongue is configured to engage the cable connector in a locking position.

According to another aspect, a system for securing a cable assembly to an electronic module. The system comprises a first housing, a connector position assurance device, and a cable. The first housing includes a connector port with a socket and a retention tab. The first housing includes a wall having an outer surface. The connector position assurance device is movably coupled to the first housing. The connector position assurance device includes an actuation tab positioned on the outer surface of the wall and a locking arm extending into the connector port. The cable includes a conductive element and a locking member. The conductive element of the cable is received in the socket of the first housing.

The system of the preceding paragraph can optionally include, additionally and/or alternatively any, one or more of the following features/steps, configurations and/or additional components.

For example, the system may further include a slot extending through the wall of the first housing. The connector position assurance device extends through the wall and is movable along the slot of the first housing.

The system may further include the connector position assurance device movable from a release position to a lock position within the connector port of the first housing to engage the locking member of the cable.

The system may further include the outer surface of the wall including a detent to engage the actuation tab of the connector position assurance device in the lock position.

The system may further include the locking member of the cable positioned between a tongue of the locking arm and the retention tab of the first housing to lock the cable assembly to the electronic module in the lock position.

The system may further include receiving the cable within the socket which flexes the connector position assurance device to move a locking pin of the connector position assurance device into the socket.

According to another aspect, a connector position assurance assembly for an electronic module. The connector position assurance assembly comprises a connector position assurance device including an actuation tab and an intermediate tab oriented parallel to the actuation tab. A dividing member is positioned between the actuation tab and the intermediate tab. A locking arm is connected to the intermediate tab via a frame member. The locking arm includes a tongue and a locking pin forming a receiving slot therebetween.

The connector position assurance assembly of the preceding paragraph can optionally include, additionally and/or alternatively any, one or more of the following features/steps, configurations and/or additional components.

For example, the connector position assurance assembly may further include the frame member is flexible in a direction away from the intermediate tab.

The connector position assurance assembly may further include the receiving slot configured to receive a locking member of a cable therebetween.

The connector position assurance assembly may further include the actuation tab slidable on an outer surface of the electronic module to move the connector position assurance device between a release position and a locking position.

The connector position assurance assembly may further include the actuation tab including a flexible biased member to engage an outer surface of the electronic module.

1. An electronic module, comprising:
a first housing including:
a connector port including a socket configured to receive a conductive element of a cable; and
a wall including an outer surface; and
a connector position assurance device including:
an actuation tab positioned on the outer surface of the wall of the first housing;
a locking arm extending into the connector port and movably coupled to the first housing; and
a frame member coupling the actuation tab to the locking arm.

2. The electronic module of claim 1, wherein the connector port includes a retention channel configured to engage a cable connector, wherein a bifurcation wall is positioned between the socket and the retention channel.

3. The electronic module of claim 1, wherein the locking arm is movable from a release position on the first housing to a locking position within the connector port of the first housing to engage a cable connector.

4. The electronic module of claim 1, wherein the wall of the first housing includes an inner surface, wherein a slot extends through the inner surface and the outer surface of the wall, and wherein the connector position assurance device is slidably coupled with the slot.

5. The electronic module of claim 2, wherein the connector position assurance device includes a locking pin positioned in the connector port of the first housing.

6. The electronic module of claim 5, wherein the locking pin abuts a retention tab positioned on the bifurcation wall when the connector position assurance device is in a release position, wherein the retention tab prevents actuation of the connector position assurance device.

7. The electronic module of claim 6, wherein the bifurcation wall of the first housing is positioned between the tongue and the locking pin in the locking position.

8. The electronic module of claim 7, wherein the locking arm of the connector position assurance device is urged upon receiving the conductive element of the cable within the socket, wherein the locking pin is disengaged from the retention tab upon receiving the conductive element of the cable within the socket.

9. The electronic module of claim 1, wherein the locking arm includes a tongue, wherein the tongue is configured to engage the cable connector in a locking position.

10. A system for securing a cable assembly to an electronic module, the system comprising:
a first housing, including:
a connector port including a socket and a retention tab, and
a wall including an outer surface;
a connector position assurance device movably coupled to the first housing, the connector position assurance device including an actuation tab positioned on the outer surface of the wall and a locking arm extending into the connector port; and
a cable including a conductive element and a locking member, wherein the conductive element is received in the socket.

11. The system of claim 10, wherein the first housing includes a slot extending through the wall, wherein the connector position assurance device extends through the wall and is movable along the slot of the first housing.

12. The system of claim 10, wherein the connector position assurance device is movable from a release position to a lock position within the connector port of the first housing to engage the locking member of the cable.

13. The system of claim 12, wherein the outer surface of the wall includes a detent to engage the actuation tab of the connector position assurance device in the lock position.

14. The system of claim 13, wherein the locking member of the cable is positioned between a tongue of the locking arm and the retention tab of the first housing to lock the cable assembly to the electronic module in the lock position.

15. The system of claim 10, wherein receiving the cable within the socket flexes the connector position assurance device to move a locking pin of the connector position assurance device into the socket.

16. A connector position assurance device for an electronic module, the connector position assurance device comprising:
an actuation tab,
an intermediate tab oriented parallel to the actuation tab,
a dividing member positioned between the actuation tab and the intermediate tab, and
a locking arm including a tongue and a locking pin forming a receiving slot therebetween, and a frame member connecting the locking arm to the intermediate tab.

17. The connector position assurance assembly of claim 16, wherein the frame member is flexible in a direction away from the intermediate tab.

18. The connector position assurance assembly of claim 16, wherein the receiving slot is configured to receive a locking member of a cable therebetween.

19. The connector position assurance assembly of claim 16, wherein the actuation tab is slidable on an outer surface of the electronic module to move the connector position assurance device between a release position and a locking position.

20. The connector position assurance assembly of claim 16, wherein the actuation tab includes a flexible biased member to engage an outer surface of the electronic module.
